(19) United States
(12) Patent Application Publication
(10) Pub. No.: US 2006/0238830 A1
(43) Pub. Date: Oct. 26, 2006

(54) Color image capture system

(76) Inventor: Peter Dikeman, Wayland, MA (US)

Correspondence Address: Iandiorio & Teska, 260 Bear Hill Road, Waltham, MA, 02451-1018, US

(21) Appl. No.: 11/111,529

(22) Filed: Apr. 21, 2005

(51) Int. Cl. H04N 1/46

(52) U.S. Cl. 358/500; 358/509; 358/518

(57) ABSTRACT

A color image capture system and method includes an illumination source for directing monochromatic light and light of N different colors, where N is a number greater than or equal to two, to an image to be captured. An image sensor senses light reflected from or transmitted through the image and produces an image signal in response. A controller subsystem is responsive to the image signal. The controller subsystem is configured to control the illumination source to expose at least a portion of the image monochromatically, expose the portion of the image N times with the N colors, one at a time.

### FIELD OF THE INVENTION

This invention relates to a color image capture system such as a document scanner and in one example, a small document or business card scanner.

### BACKGROUND OF THE INVENTION

Color image capture systems such as document (e.g., business card) scanners are relatively slow compared to monochromatic scanners. As known and as utilized herein, monochromatic refers to gray scale, or white or near white light. But, the marketplace demands the production of color images even for business card scanners.

One way to speed up a color scanner is by compressing the color image data to a more compact format so that less data needs to be sent to a host computer. But, many compression schemes require additional computational power and memory (e RAM) in the scanner. Memories in particular are expensive and thus result in a more costly scanner. Also, many compression schemes result in a loss of image quality and some take too long to complete the compression function. Further, many one-dimensional compression algorithms can result in requiring more space than uncompressed data when the data is non-repetitive.

Moreover, there is an upper limit to the speed of scanning when color data is obtained in the traditional manner. For one dimensional sensors, for example, there cannot be any significant movement of the document between the color, i.e. red, blue, and green, exposures of a scan line. Otherwise color mis-registration will be introduced which will adversely affect the visual presentation of the image, as well as the results of any image analysis program (IAP) such as optical character recognition (OCR). Also, motion artifacts are more likely as the scan speed in a color scanner is increased.

Thus, there is the delay in scanning in the color regime while the document and the document motion mechanism come to a complete stop or nearly a complete stop before a scan line is imaged by the red, green, and then blue light sources.

Also, with known one-dimensional color scanners, and even with known two-dimensional color scanners, two options for scanning the image and transferring the image data are known. One option is to scan the image, and compress all of the data, which would necessarily include the monochromatic data. This option has the disadvantage of resulting in low quality monochromatic data, such that it is not suitable for uses requiring high resolution, such as optical character recognition (OCR). Another option is to not compress the data. The fidelity of monochromatic data is preserved, but a large amount of data will need to be transferred relative to what is required of an image analysis program ( i.e. OCR).

For many color imaging systems, the goal is high spatial resolution and excellent color fidelity. To increase speed, expensive processors and memory devices are used and a high bandwidth connection is required to transfer the image data in a timely fashion. There are, however, certain systems wherein high quality, high resolution color images are not required. One example is a business card scanner. The most important information on a business card is the person's name, company name, telephone number, e-mail address, and the like. Colored logos and the like on the business card are scanned but the primary reason to image and digitize these colored logos during a scan is to present the user with a reasonable representation of the business card on the user's computer monitor. There is simply no need for a high quality replication of the colored logo.

### SUMMARY OF THE INVENTION

It is therefore an object of this invention to provide a less costly color image capture system.

It is a further object of this invention to provide a color image capture system which does not require an expensive memory on-board the scanner.

It is a further object of this invention to provide a faster color image capture system.

It is a further object of this invention to provide a color image capture system that provides both full resolution monochromatic data and compressed color data.

The subject invention results from the realization that the cost of color imaging can be reduced by eliminating the memory required for traditional scanning and compression schemes and that the speed of color imaging can be increased by monochromatically exposing an image or scan line and then exposing the same image or scan line using only, for example, two different colors. The subject invention also results from the further realization that by utilizing a combination of monochromatic light exposure and at least two different color light exposures, or monochromatic light exposure and sensors configured to sense monochromatic light and light of two different colors, both full resolution monochromatic data and compressed color data can be sent in one scan or in one image. Since the color data is preferably compressed using a simplified compression algorithm, no expensive memory or processors are required. Based on the monochromatic exposure and data and the two color exposures and data, a third color can be derived, or more generally, based on the monochromatic exposure and any number of different color exposures, an unknown or missing color can be derived. And, since the monochromatic exposure is not subject to color registration issues, the scanning time for line scanners can be reduced to the point where a color scan is almost as fast as a monochromatic scan. Also, speed is increased without loss of resolution of monochromatic data. The resulting color image may not be as sharp as when, i.e. three different color exposures are used instead of two, but, in many implementations (e.g., business card and other small document scanners), there is no need for a perfect high quality color image. Moreover, the monochromatic exposure has other benefits. When all three color light sources are used, for example, the exposure light is brighter resulting in a shorter exposure time producing a better and faster scan.

As noted, the invention is not limited to light sources of only three colors. Any number of light sources that produce monochromatic light when combined may be used so that the monochromatic data and the data from all but one of the color light sources can be used to create data that would normally come from the missing light source, i.e. the missing color information.

Also, more generally the concepts and algorithms presented herein apply to any situation in which a source for full resolution color data is available and that data needs to be transferred to a receiver where such receiver requires high resolution monochromatic data but lower quality color data.

This invention features a color image capture system including an illumination source for directing monochromatic light and light of N different colors, where N is a number greater than or equal to two, to an image to be captured, and an image sensor for sensing light reflected from or transmitted through the image and to produce an image signal in response. A controller subsystem is responsive to the image signal and configured to control the illumination source to expose at least a portion of the image monochromatically, expose the portion of the image N times with the N colors, one at a time, to thereby speed up the exposure of the image and/or reduce the memory and processor requirements of the capture system. The controller subsystem may be further configured to output full resolution monochromatic data in response to the monochromatic exposure and to output compressed color data in response to the color exposures. The color image capture system may further include an image processing subsystem responsive to the full resolution monochromatic data and the compressed color data. The image processing subsystem may be configured to derive missing color information from the compressed color data and the monochromatic data. The image processing subsystem may be configured to derive at least a third color from the compressed color data and the monochromatic data and may further include an optical character recognition program for detecting image characters based on the monochromatic data. The controller subsystem may be configured to output color difference signals based on the monochromatic data. The color image capture system may include an image processing subsystem configured to derive color information from the color difference signals and the monochromatic data. The controller subsystem may be configured to ignore predetermined least significant bits of the color data in order to compress the color data. The illumination source may include multiple light-emitting diodes configured to produce monochromatic light. The illumination source may include red, green, and blue light-emitting diodes and the controller subsystem may be configured to energize the red, green, and blue light emitting diodes simultaneously to monochromatically expose the portion of the image. The controller subsystem may also be configured to energize only one of the red, green, and blue light emitting diodes to expose the image portion with one color and to energize only one other color light emitting diode to expose the image portion with another color. The image sensor may include photodiodes which may be arranged in a linear array or a two dimensional an-ay. The color image capture system may further include a motion mechanism for providing relative motion between a document containing the image and the image sensor.

In one embodiment, the controller subsystem may include a memory buffer, and the controller subsystem may be configured to compensate for dark current. The memory buffer may be less than 100 bytes, and the memory buffer may be 64 bytes.

This invention also features a document scanning system including an imaging subsystem that includes an illumination source including N differently colored light sources, where N is a number greater than or equal to three, and an image sensor for sensing light reflected from or transmitted through the document and for producing an image signal in response. A motion mechanism provides relative motion between the imaging subsystem and the document. A controller subsystem is responsive to the image signal and for controlling the illumination source and the motion mechanism. The controller subsystem is configured to pulse on predetermined light sources simultaneously to expose at least a portion of the document monochromatically, pulse on one of the light sources to expose the portion of the document in one color, and pulse on the remaining light sources N-2 times with a different light source each time. The controller subsystem may be further configured to output full resolution monochromatic data in response to the monochromatic exposure and to output compressed color data in response to the color exposures. The document scanning system may further include an image processing subsystem responsive to the fill resolution monochromatic data and the compressed color data. The image processing subsystem may be configured to derive at least a third color from the compressed color data and the monochromatic data. The image processing subsystem may be configured to derive missing color information from the compressed color data and the monochromatic data. The image processing subsystem may further include an optical character recognition program for detecting image characters based on the monochromatic data. The controller subsystem may be configured to output color difference signals based on the monochromatic data, and the image processing subsystem may be configured to derive color information from the color difference signals and the monochromatic data. The controller subsystem may be configured to ignore predetermined least significant bits of the color data in order to compress the color data. The light sources may be light emitting diodes, and the light sources may be red, green, and blue light-emitting diodes. The image sensor may include photodiodes which may be arranged in a linear array or a two dimensional array.

This invention further features a method of capturing an image, the method including exposing at least a portion of an image monochromatically to produce a monochromatic image signal, exposing at least a portion of the image with light of N different colors, where N is a number greater than or equal to 2, to produce N color image signals, compressing the color image signals, and resolving missing color information from the compressed N color image signals and the monochromatic image signal.

This invention further features a method of capturing an image, the method including exposing at least a portion of an image monochromatically to produce a monochromatic image signal, exposing the portion of an image with light of a first color to produce a color image signal, exposing the portion of an image with light of a second color to produce a second color image signal, compressing the first and second color image signals, and resolving a third color image signal from the compressed color image signals and the monochromatic image signal. The method of capturing an image may further include detecting characters present in the image from the monochromatic image signal. Detecting characters present in the image from the monochromatic image signal may be performed by an optical character recognition program. Compressing the first and second image signals may include ignoring predetermined least significant bits of color image data. The method of capturing an image may further include moving the document containing the image after exposing the portion of the image with light of a second color.

Exposing at least a portion of the image monochromatically may include energizing red, green and blue light emitting diodes simultaneously. Exposing at least a portion of the image with light of the first color may include energizing a first light emitting diode to expose the image portion with the first color, and the first color may be red. Exposing at least a portion of the image with light of the second color may include energizing a second light emitting diode to expose the image portion with the second color, and the second color may be green. The monochromatic image signal may include full resolution monochromatic data, and the first and second compressed color image signals may include compressed color image data for the first signal and compressed color image data for the second signal.

This invention also features a method of document scanning, the method including pulsing on a plurality of color light sources simultaneously to expose at least a portion of a document monochromatically, pulsing on a first color light source to expose the portion of the document to a first color, pulsing on a second color light source to expose the portion of the document to a second color, sensing light reflected from or transmitted through the document, and producing an image signal in response.

This invention also features a method of document scanning, the method including pulsing on a first color light source, a second color light source, and a third color light source simultaneously to expose at least a portion of a document monochromatically, pulsing on the first color light source to expose the portion of the document to the first color, pulsing on the second color light source to expose the portion of the document to the second color, sensing light reflected from or transmitted through the document, and producing an image signal in response. The method of document scanning may further include providing relative motion between the light sources and the document after exposing the document portion to the second color.

The method of document scanning may further include outputting full resolution monochromatic data in response to exposing the document portion to the first, second, and third light simultaneously, and may further include outputting first color data in response to exposing the document portion to the first color. The method may further include outputting second color data in response to exposing the document portion to the second color, and may include compressing the first color data, and may also include compressing the second color data. Compressing the first and second color data may include ignoring least significant bits of said first and second color image data or may include averaging the first and second color image data. The method may further include deriving a third color from the compressed first and second color data and the monochromatic data The method of document scanning may further include detecting image characters based on the full resolution monochromatic data, and may further include outputting color difference signals based on the full resolution monochromatic data. The method of document scanning may include deriving color data from the color difference signals.

This invention further features a method of capturing an image, the method including directing monochromatic light onto an image to be captured, sensing monochromatic light reflected from the image and producing monochromatic image data, directing light of at least a first color onto the image to be captured, sensing the first color light reflected from the image and producing first color image data, directing light of at least a second color onto the image to be captured, sensing the second color light reflected from the image and producing second color image data, compressing the first and second color image data, and producing an image signal in response.

This invention also features a color image capture system including an illumination source for directing monochromatic light to an image to be captured, an image sensor including at least three sensing elements for sensing light reflected from or transmitted through the image and to produce an image signal in response, with two of the sensing elements configured to be sensitive to a different predetermined color. A controller subsystem is responsive to the image signal and configured to control the illumination source to expose at least a portion of the image monochromatically and further configured to output full resolution monochromatic data and to output compressed color data.

This invention further features a color image capture system including an illumination source for directing monochromatic light and light of at least first and second colors to an image to be captured, an image sensor for sensing light reflected from or transmitted through the image and to produce an image signal in response, and a controller subsystem, responsive to the image signal and configured to control the illumination source. The controller subsystem is configured to: expose at least a portion of the image monochromatically, output full resolution monochromatic data in response to the monochromatic exposure, and transmit the full resolution monochromatic data to a computing device; expose the portion of the image with the first color, output compressed first color data in response to the first color exposure, and transmit compressed first color data to the computing device; and expose the portion with said second color, output compressed second color data in response to the second color exposure, and transmit compressed second color data to the computing device. The color image capture system may further include an image processing subsystem responsive to the full resolution monochromatic data and the compressed color data. The image processing subsystem may be configured to derive a third color from the compressed color data and the monochromatic data.

This invention also features a color image capture system including an illumination source for directing light to an image to be captured, an image sensor for sensing light reflected from or transmitted through the image and to produce an image signal in response, and a controller subsystem, responsive to the image signal and configured to output full resolution monochromatic data and transmit the full resolution monochromatic data to a computing device, output compressed color data of a first color and transmit the compressed first color data to the computing device, and output compressed color data of a second color and transmit the compressed second color data to the computing device. The color image capture system may further include an image processing subsystem responsive to the full resolution monochromatic data and the compressed color data. The image processing subsystem may be configured to derive a third color from the compressed color data and the monochromatic data.

This invention further features a method of capturing an image including exposing at least a portion of an image monochromatically to produce a monochromatic image signal, outputting full resolution monochromatic data in response to the monochromatic exposure, and transmitting the full resolution monochromatic data to a computing device. The method further includes exposing the portion of the image with light of a first color to produce a first color image signal, outputting compressed first color data in response to the first color exposure and transmitting the compressed first color data to the computing device. The method also includes exposing the portion of the image with light of a second color to produce a second color image signal, outputting compressed second color data in response to the second color exposure and transmitting the compressed second color data to the computing device. The method of capturing an image may include the step of resolving a third color image signal from the compressed first and second color image signals and the monochromatic image signal.

This invention also features a method of capturing an image including exposing at least a portion of an image to monochromatic light, sensing light reflected from or transmitted through the image and producing an image signal from said sensed light. The method also includes outputting full resolution monochromatic data and transmitting said full resolution monochromatic data to a computing device, outputting compressed first color data and transmitting said compressed first color data to the computing device, and outputting compressed second color data and transmitting said compressed second color data to the computing device. The method of capturing an image may further include the step of resolving a third color image signal from the compressed first and second color image signals and the monochromatic image signal.

This invention further features a method of capturing an image, the method including exposing at least a portion of an image monochromatically to produce a monochromatic image signal, outputting full resolution monochromatic data in response to the monochromatic exposure, and transmitting the full resolution monochromatic data to a computing device; exposing the portion of the image with light of a first color to produce a first color image signal, outputting compressed first color data in response to the first color exposure, and transmitting the compressed first color data to the computing device; exposing the portion of the image with light of a second color to produce a second color image signal, outputting compressed second color data in response to the second color exposure, and transmitting the compressed second color data to the computing device; and compensating for dark current each time before exposing the portion of the image monochromatically, with light of the first color, and with light of the second color.

This invention also features a method including producing partial color image data, producing monochromatic image data, and from the partial color image data and the monochromatic image data, deriving low resolution full color image data. The method may further include that both the partial color image data and the monochromatic image data are derived from high resolution full color image data.

### BRIEF DESCRIPTION OF THE DRAWINGS

Other objects, features and advantages will occur to those skilled in the art from the following description of a preferred embodiment and the accompanying drawings, in which:

FIG. 1 is a schematic diagram showing one configuration of the document scanning system in accordance with the present invention;

FIG. 2 is a schematic diagram showing one configuration of the color image capture system of the present invention;

FIG. 2A is a schematic enlarged view of photodiodes for use with the present invention;

FIG. 3 is a flow chart depicting the primary processing steps associated with the operation of a prior art scanner;

FIG. 3A is a flow chart depicting the primary processing steps associated with the operation of the prior art scanner of FIG. 3 showing typical steps including storage of data in memory buffer locations;

FIG. 4A is a flow chart depicting the primary processing steps associated with the operation of one example of a scanner in accordance with the present invention;

FIG. 4B is a flow chart depicting the primary processing steps associated with the operation of another example of a scanner in accordance with the present invention;

FIG. 4C is a flow chart depicting the primary processing steps associated with the scanner of FIG. 4A, further including steps for dark current compensation in accordance with the present invention;

FIG. 4D is a flow chart depicting the primary processing steps associated with the scanner of FIG. 4B, further including steps for dark current compensation in accordance with the present invention;

FIG. 5 is a schematic view of compressed color data in the form of color difference signals for use in accordance with the present invention;

FIG. 6 is a schematic representation of the use of the monochromatic and two color data of FIG. 5 with the present invention;

FIG. 7 is a schematic representation of the use of another form of monochromatic and two color data with the present invention;

FIG. 8 is a schematic diagram showing a more detailed view of one embodiment the image capture system of FIG. 2;

FIG. 9. is a schematic view of full uncompressed monochromatic data in 8-bit format for use in accordance with the present invention;

FIG. 10 is a schematic view of compressed color data in 8-bit format for use in accordance with the present invention;

FIG. 11 is a schematic diagram showing a more detailed view of another embodiment of the image capture system of FIG. 2;

FIG. 12 is a flow chart depicting the primary steps associated with the operation of another example of a scanner in accordance with the present invention; and

FIG. 13 is a flow chart depicting the primary steps of the general inventive algorithm of the subject invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

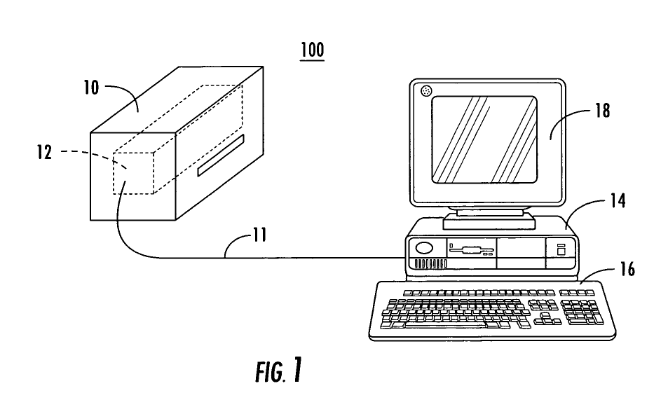

FIG. 1 shows document scanning system 100 including an image capture device (ICD), such as business card scanner 10, in accordance with the present invention. Scanner 10 is connected, through communication link 11, which may be a cable, universal serial bus or wireless connection, to computing device 14. As known by those of ordinary skill in the art, computing device 14 may be a personal computer, a notebook or laptop computer, a personal Digital Assistant, or a custom computing device. Computing device 14 further includes input/output devices such as keyboard 16 and monitor 18. Scanner 10 may also be a sheet-fed or flatbed scanner or any linear or multi-dimensional imaging device including cameras. Color image capture system 12 of the subject invention is included therein.

In one example, scanner 10 scans, line by line, a document such as a business card or document or transparency with text and graphics thereon. The scanning result, generally a digital image signal, is transferred from scanner 10 to computing device 14 through communication link 11. The image may then be manipulated for desired visual effects by known computer programs in computing device 14, and the scanned or manipulated image can be displayed on monitor 18 and/or stored in a memory associated with computing device 14.

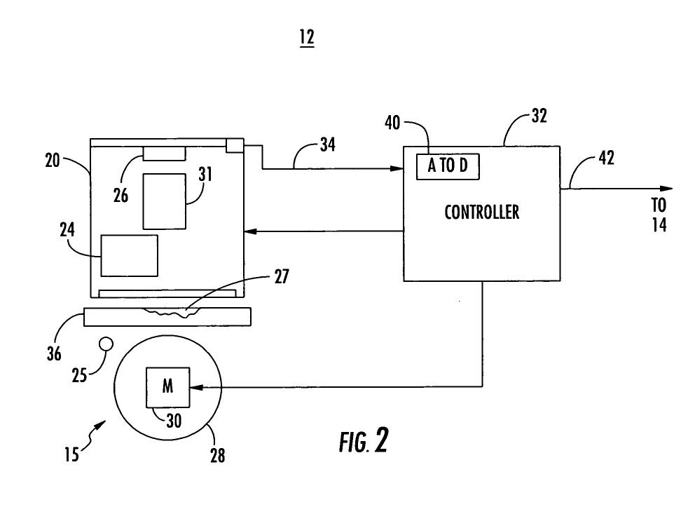

Image sensing module 20, FIG. 2, of color image capture system 12 of the subject invention includes illumination source 24 and image sensor 26. Motion mechanism 15 includes motor 30 and roller 28 which urges or moves document 36 under image sensing module 20 in order to image document 36.

Controller subsystem 32 controls motion mechanism 15 as well as illumination source 24 which typically includes red, green, and blue LEDs. However, any combination of light-emitting sources, that when combined create monochromatic light, may be used. Motion mechanism 15, as controlled by controller subsystem 32, works in synchronization with image sensing module 20 such that image sensing module 20 images document 36, such as a business card, piece of paper or transparency, while it is passing beneath image sensing module 20. A clock (not shown) provides clocking signals for synchronization, as known in the art and provided by controller subsystem 32. It will be noted that in the case of a flatbed scanner, the document remains stationary while a motion mechanism moves image sensing module 20 so that large objects may be scanned. It is clear that, in this example, motion mechanism 28 provides relative motion between document 36 containing image 27, and image sensor 26. Also, a second illumination source 25 could be included for imaging transparencies. The subject invention would work equally well with a flatbed scanner or more than one illumination source, or with a two dimensional sensor, as discussed more fully below.

Document 36 is illuminated by illumination source 24, and image sensor 26 senses light from document 36. As known to those of ordinary skill in the art, image sensor 26 typically includes photodiodes 29a, 29b . . . 29n, FIG. 2A, arranged linearly or in a two dimensional array. Photodiodes 29a, 29b . . . 29n are exposed to illumination source 24 for a predetermined time. Charges from exposed photo diodes are transferred to shift register 31 to an analog buffer 33 for gain and offset control resulting in an analog output for transfer to the analog-to-digital conversion subsystem 40, FIG. 2. A mechanism is provided to read data from one photodiode at a time, and image signal 34, FIG. 2, is produced when the document is exposed to light from illumination source 24. In general, one photodiode corresponds to one pixel, and a plurality of pixels form an image. Image signal 34 includes monochromatic image data, as well as image data from at least two colors, as will become apparent below. The incident light from illumination source 24 is typically focused onto the photodiode array in image sensor 26 by an optical rod lens 31, also as known in the art.

Controller subsystem 32 responds to image signal 34 produced by image sensor 26, and image signal 34 is then digitized, typically by analog-to-digital converter or conversion subsystem 40. Digital signals representing document 36 undergo further processing using known techniques and software programs, to present digital signals 42 for transmission to computing device 14. Controller subsystem 32 also provides timing and control signals to illumination source 24 and image sensor 26, as discussed below. Controller subsystem 32 may be included in computing device 14, FIG. 1, similar to the configuration taught in U.S. Pat. No. 6,275,309, incorporated herein by reference, but controller subsystem 32, FIG. 2 may also be located in the scanning device 10, FIG. 1.

In known image capture systems, for a monochromatic scan, the image capture system includes an illumination source that is monochromatic, such as white light, and the resulting image is in black and white and gray scale. The resulting image comprises a plurality of pixels represented by a numerical value signifying the intensity of the light, for example, reflected from a document onto an image sensor. This numerical data may be in 8-bit or other format. In one example, if the numerical data is in 8-bit format, and a pixel has a numerical value of 255, that pixel is white. If a pixel has a numerical value of 0, it is black. Pixels having data values between 0 and 255 represent variations between white and black, i.e. gray scale. Such a gray scale image is satisfactory for most uses, including optical character recognition (OCR) programs that may be resident in computer 14, where an image of printed text captured by a scanner or other ICD is translated into computer-editable text, or into a standard encoding scheme representing the image.

In such known systems, to achieve a color scan, the illumination source corresponding to illumination source 24, FIG. 2, is typically comprised of red, green, and blue LEDs, each of which can be independently turned on and off. In the prior art, for every line to be scanned (“scanning line”) on the document, each of the red, green and blue LEDs is turned on alternately and in succession, while the motion mechanism is stopped and the document does not move. If the motor is not completely stopped, or at a very low velocity, undesirable color registration issues may arise.

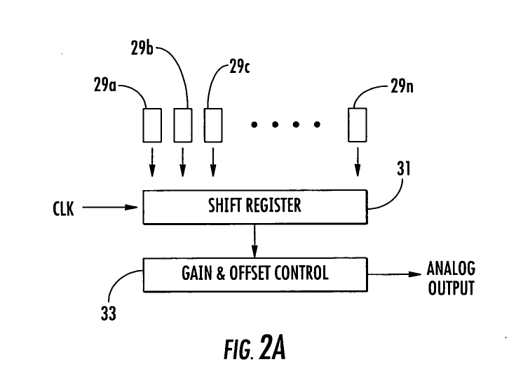

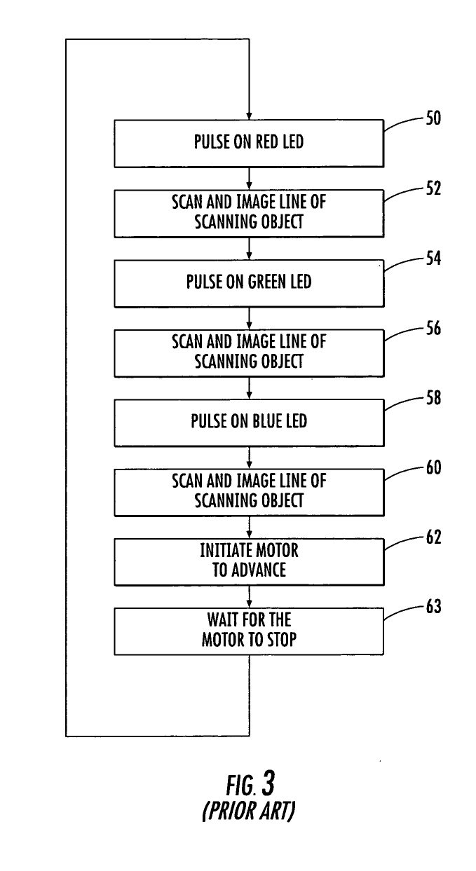

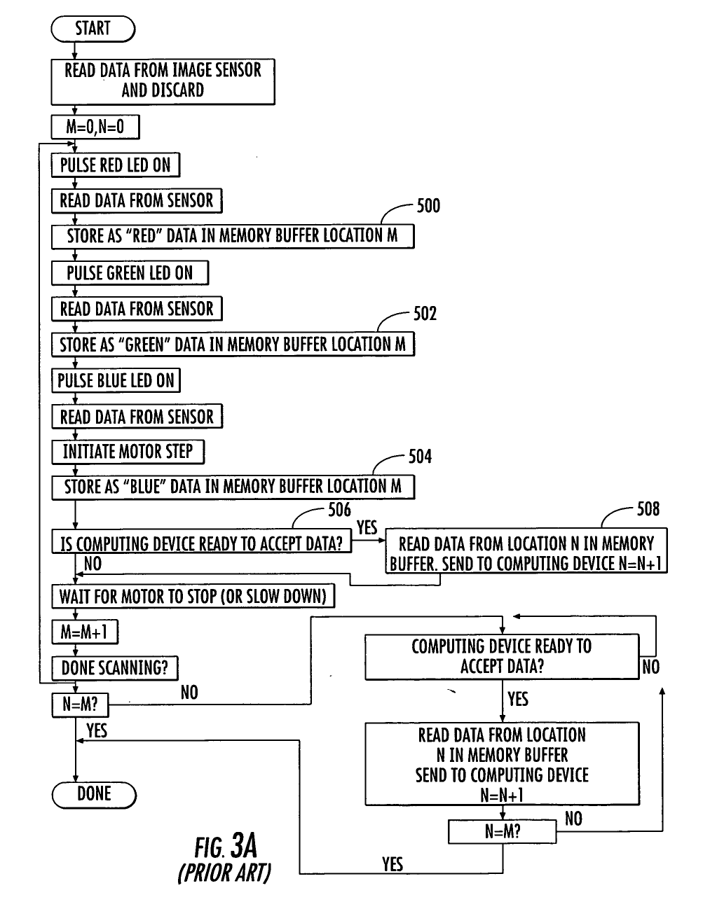

For example, the motion mechanism stops the document, only the red light is pulsed on, step 50, FIG. 3, and one line of the document is scanned and imaged by the image sensor, step 52. The green light is pulsed on, step 54, and the same line of the document is scanned and imaged by the image sensor, step 56. Then the blue light is pulsed on, step 58, and the same line of the document is scanned and imaged by the image sensor, step 60. Thereafter, the motion mechanism causes the motor to advance, step 62, thus moving the document so that the next scanning line may be scanned in the same way. Then, the system must wait for the motor to stop, step 63, before again pulsing the red light on to begin the scan of the next line.

Not only are prior art systems slower and less efficient, but they also require a relatively large memory buffer on the order of many kilobytes to megabytes. Known color or monochromatic imaging systems transfer image data from an image sensor at a fixed rate to a memory buffer capable of holding multiple lines of image data. The buffer serves to smooth the flow of data between the ICD and the computing device. This is done so that lines of image data may be scanned at a near constant rate to avoid issues of uneven dark current buildup which will cause an undesirable variation in contrast from one scan line to the next. In addition, this buffer may also be used to implement compression algorithms.

FIG. 3A is a flow chart depicting the primary processing steps associated with the operation of the prior art scanner of FIG. 3 showing typical steps including storage of data in memory buffer locations. In such a prior art system, a constant scan rate is insured with the use of a memory buffer, such that dark current will be consistent from one (scanned) line to the next so that it may be calibrated out in the computing device. M and N symbolize addresses or locations in the memory buffer, M symbolizing the address or location of data to be taken into the memory buffer, and N symbolizing the address of data to be taken out of the memory buffer. As shown, in steps 500, 502 and 504, red, green and blue data, respectively, are required to be stored in the memory buffer. When the computing device is ready to accept the data, step 506, the data is read from location N the memory buffer, step 508.

With such known color image capture systems, the resulting data is more than is adequate for optical character recognition (OCR) purposes. Moreover, in known linear scanning systems, such as the known system described above, the speed at which scanning can take place is limited. First, the motor must be virtually stopped and each scanning line of the document scanned by each color before the next motor step can be taken. Otherwise, as noted, the resulting image will exhibit adverse registration issues including blurring, artifacts, fringing effects and shadows. Also, providing memory in the scanner is relatively expensive, and would require purchase of substantially more memory than required for the present invention, thus undesirably increasing the cost of the scanner.

Also as noted in the Background section above, in an attempt to increase scanning speed, typical ICDs resort to image capture systems which compress the image data to a more compact format. Since less data is transmitted to the computing device, data transmission can be accomplished more quickly. There are basically two types of data compression: lossy and lossless. A common lossy format utilized by many ICDs such as scanners and cameras is JPEG. An example of lossless compression is the Lempel Ziv Welch (LZW) algorithm which is used to encode GIF graphic files. Lossy compression requires substantial computational and memory resources in the ICD, and there is an inherent loss of image quality. Lossless compression such as LZW and run length encoding (RLE) require low to moderate resources and there is no loss of information. However, the amount of compression that may be achieved may be limited, depending upon the character of the data. For example, in RLE if the run lengths of repetitive data are short then not much compression will be achieved and in the worst case there will actually be more data sent than was contained in the original data. Although more complex lossless algorithms can be used, they require more resources at the ICD. Thus, known image capture systems utilize monochromatic light such as a white light illumination source for monochromatic scans, or three color LEDs each of which are pulsed on in sequence as the illumination source for color scans, line buffer memories to allow a near constant rate for scanning of lines, together with lossy or lossless compression when higher scan speeds are desired. These devices transfer either monochromatic data or color data for a single pass of a scanned document, but not both.

In contrast, the color image capture system and method of the subject invention includes the ability to use both monochromatic and color light as the illumination source in conjunction with an image sensor and a controller subsystem, and does so in such a manner that the speed of the scan and data transfer is increased. Also, data sufficient for both high accuracy image analysis (i.e. OCR) and lower fidelity color images is transmitted during a single pass of a scanned document. The color image capture system and method of the present invention implements a compression scheme in which monochromatic data is sent at full resolution and color data is sent in a compressed format. The full resolution monochromatic data may be uncompressed, or it may be compressed with lossless or very low loss compression such that the integrity is sufficient for high accuracy image analysis. The scanning algorithm of the present invention also precludes the need for an image line buffer by compensating for a non-constant line scanning rate.

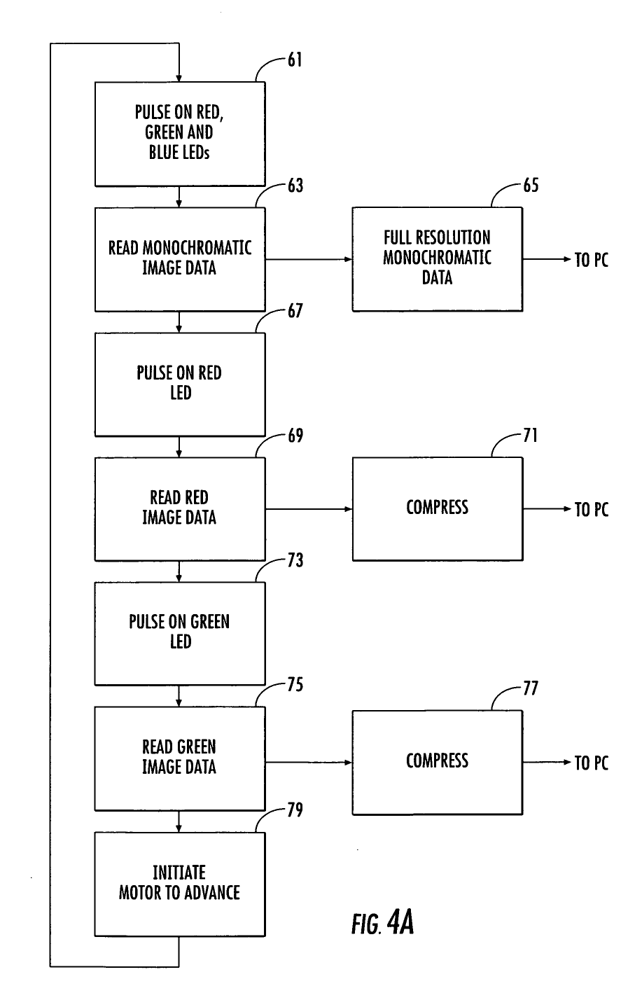

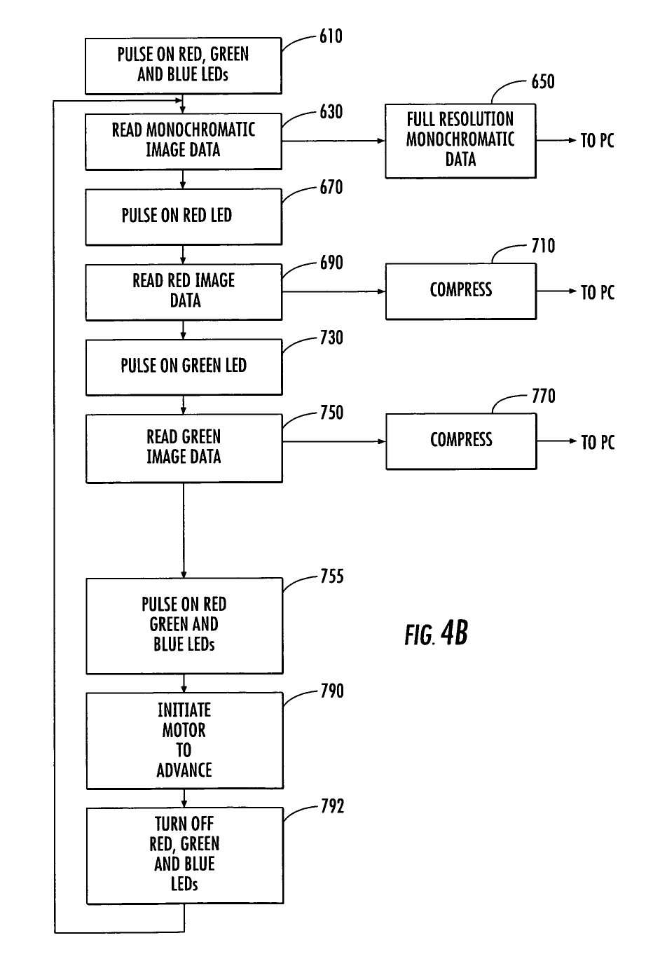

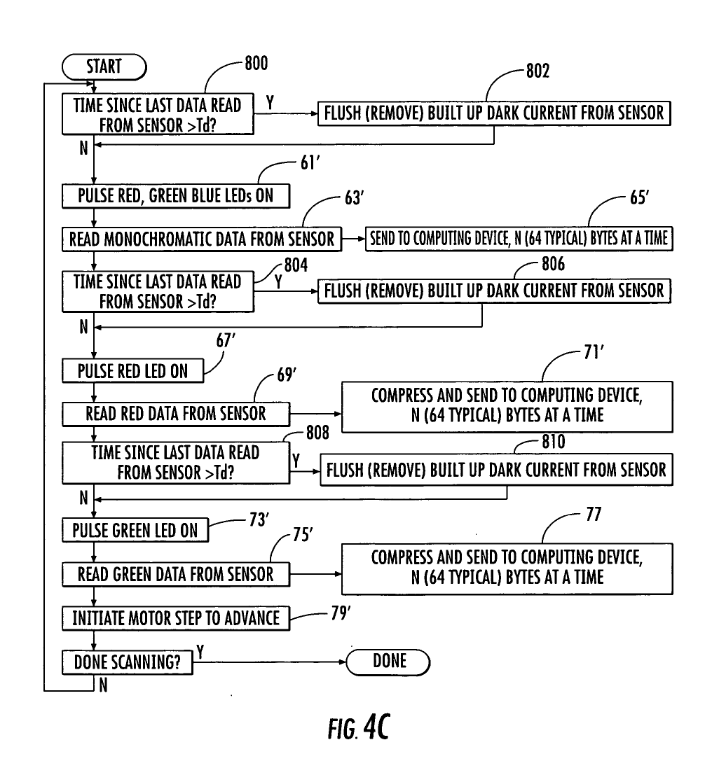

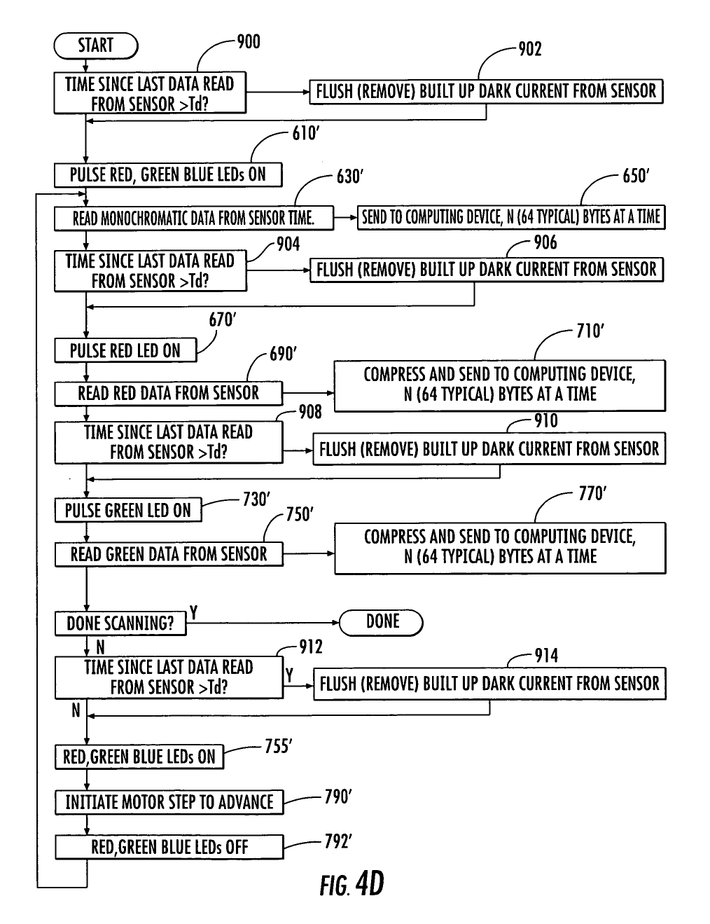

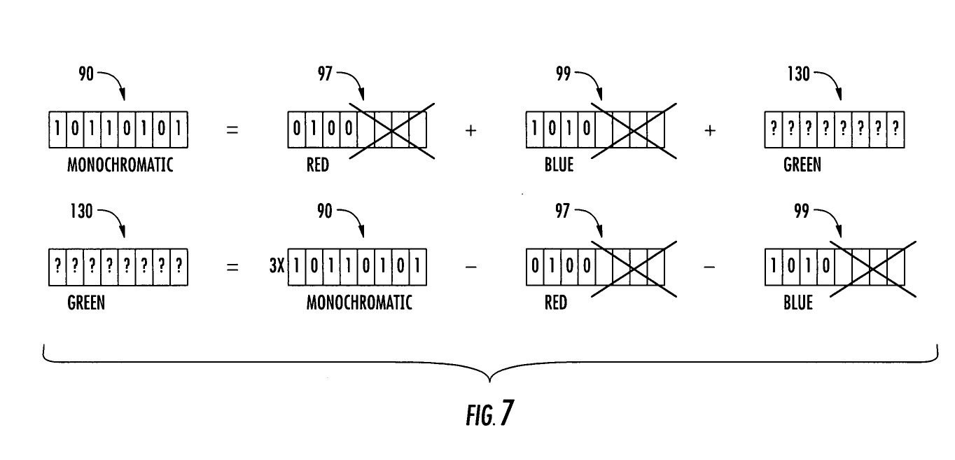

FIG. 4A schematically illustrates in flow chart form the primary steps associated with the operation of controller 32, FIG. 2 and of the operation and interconnection between the elements of the present invention. Further details of the operation and the elements, including various alternatives of these which still fall within the present invention, are set forth more fully below. In particular, the discussions of FIG. 8 below describes an alternate configuration of the system of this invention. However, in all examples and embodiments, full resolution monochromatic data or monochromatic data uncompressed or compressed by lossless compression, is transmitted to a computing device separately from compressed color data. Thus, the system and method of the subject invention provides data sufficient for high accuracy image analysis (i.e. OCR) and for color images.

Also, as noted, the invention is not limited to light sources of only three colors. Any predetermined number of light sources that produce monochromatic light, i.e. a plurality of light sources N, where N is a number greater than or equal to 2, may be used so that monochromatic data and the data from all but one (i.e. N-1) of the color light sources can be used to derive data that would normally come from the missing light source, i.e. the missing color information or data. For simplicity of description, in this example, monochromatic light and red, green and blue light are discussed with blue as the “missing” color information. The data from the missing light source is third color data (blue in this example) to be derived, as discussed more below.

In step 61, FIG. 4A, the red, green and blue LEDs are pulsed on, creating monochromatic light from illumination source 24, FIG. 2, and monochromatic image data is output by image sensor 26 therefrom. The use of LEDs is not a necessary limitation of the invention, and the light sources may be any known or applicable light source.

The monochromatic image data is read by controller 32, step 63, FIG. 4A, and full resolution monochromatic data is transmitted, step 65, to the computing device such as a PC. Also, because the monochromatic data is forwarded separately from color image data, a different compression scheme may be used for the monochromatic image data than the compression schemes for the color image data, such that various combinations of compression schemes may be utilized to increase the system speed depending on a particular use or need, a major advantage.

As further shown in FIG. 4A, only the red LED is then pulsed on, step 67, creating red image data. The red image data is read, step 69, then compressed and transmitted, step 71, to the computing device. Thereafter, only the green LED is pulsed on, step 73, creating green image data. The green image data is read, step 75, then compressed and transmitted, step 77, to the computing device. In step 79, the motor advances to the next scanning line to begin the process for that next scanning line. In the example of a sheet-fed scanner, the motor step causes roller 28, FIG. 2, to move document 36 a step to the next scanning line.

In another sequence example, FIG. 4B, in step 610 the red, green and blue LEDs are pulsed on, creating monochromatic light from illumination source 24. When the monochromatic image data is read by controller subsystem 32, step 630, full resolution monochromatic data is thereafter transmitted, step 650, to the computing device such as a PC. The red LED only is then pulsed on, step 670, creating red image data. The red image data is read, step 690, then compressed and transmitted, step 710, to the computing device. Thereafter, the green LED only is pulsed on, step 730, creating green image data. The green image data is read, step 750, then compressed and transmitted, step 770, to the computing device. In step 755, the red, green and blue LEDs are pulsed on, creating monochromatic light from illumination source 24. In step 790, the motor takes a step to the next scanning line to begin the process for that next scanning line. By having step 755 of pulsing on the red, green and blue LEDs immediately precede initiating the motor step, step 790, scanning time is saved by overlapping the two steps and taking advantage of the fact that there is a much shorter exposure time for monochromatic light because three LEDs are being used and the motor is at a slow velocity. This combination gives a strobe effect that results in very good monochromatic image quality even though the motor is moving while the exposure is taking place. In step 792 the red, green and blue LEDs are turned off. There will be a one line mis-registration of red/green data with respect to monochromatic data, but this may be easily taken in to account, as known by those of ordinary skill in the art, when the data is processed by image processing system 120 if maximizing color data quality is of sufficient importance.

Notably then, in contrast to known linear sensor scanning systems, there is no need to wait for the motor to come to a complete stop before beginning the scan of the next line. Also, the illumination of the next line with monochromatic light may commence prior to the motor step and overlap it.

Also in accordance with the present invention, compensation is made for any dark current build up that may have occurred since the previous scan line was completed. This compensation can be accomplished by noting the amount of time since the previous scan line. If this time exceeds a threshold (dependent on sensor characteristics) then a scan line is retrieved from the sensor and discarded before the exposure, effectively eliminating the charge built up in the sensor as a result of dark current. Alternatively the sensor may have a mode that allows dumping of the dark current build up. If this can be done quickly, then it can be done as a precursor to every scan line to insure that a consistent, near zero level of accumulated dark current charge is present in the sensor. In this way the need for a line buffer to insure a constant scan rate is eliminated.

This unique system of dark current compensation does not require the large memory buffer of known systems, such as the known system and method described in connection with FIG. 3A. In contrast, the applicants achieve dark current compensation with a very small buffer of less than 100 bytes which is part of the controller subsystem, and which is typically approximately 64 bytes. This is in contrast to typical prior art memory buffers requiring many kilobytes to megabytes of memory. In one example in accordance with the subject invention, if the time since the last data was read from the image sensor exceeds a threshold value, Td, which is dependent on the characteristics of the particular image sensor, step 800, FIG. 4C, then a scan line, representative of dark current, is retrieved from the image sensor and discarded or removed, step 802. If the time does not exceed the threshold value, Td, red, green and blue LEDs are pulsed on, step 61′, monochromatic image data is read by controller 32, step 63′, and full resolution monochromatic data is transmitted, step 65′ to the computing device. The remaining processing steps are similar to the processing steps set forth in FIG. 4A, with the addition of dark current compensation steps 804 and 806 following step 63′, and dark current compensation steps 808 and 810 following step 69′.

Similarly, in the example of FIG. 4D, if the time since the last data was read from the image sensor exceeds a threshold value, Td, which is dependent on the characteristics of the particular image sensor, step 900, then a scan line, representative of dark current, is retrieved from the image sensor and discarded or removed, step 902. If the time does not exceed the threshold value, Td, red, green and blue LEDs are pulsed on, step 610′, monochromatic image data is read by controller 32, step 630′, and full resolution monochromatic data is transmitted, step 650′ to the computing device. The remaining processing steps are similar to the processing steps set forth in FIG. 4B, with the addition of dark current compensation steps 904 and 906 following step 630′, dark current compensation steps 908 and 910 following step 690′, and dark current compensation steps 912 and 914 following step 750′ if scanning is not yet completed.

Thus, the dark current compensation system and method of FIGS. 4C and 4D are in contrast to, and an improvement over, steps 500, 502 and 504 shown in FIG. 3A for prior art systems where red, green and blue data, respectively, are required to be stored in the memory buffer, and when the computing device is ready to accept the data, step 506, the data is read from location N the memory buffer, step 508.

As noted, in accordance with the subject invention, in the example where three colors are utilized, monochromatic data and data of two different colors, i.e. red and green, is transferred. In order to derive a third color, i.e. blue, from the monochromatic data and the green and red data, different algorithms may be utilized. Color image capture system 12 also includes image processing system 120 as part of controller subsystem 32, as shown in FIG. 8, and which will be discussed more fully below. As noted, controller subsystem 32, including image processing system 120, may be included in computing device 14 or may be located in the scanning device or other imaging system or device. In one example, controller subsystem 32 is configured to output color difference signals 110 and 112, FIG. 5, as known in the art and illustrated schematically, based on monochromatic data 114. Color difference signals 110 and 112 are signified by R−Y and B−Y, respectively, and monochromatic data 114 is signified by Y, also as known to those of ordinary skill in the art.

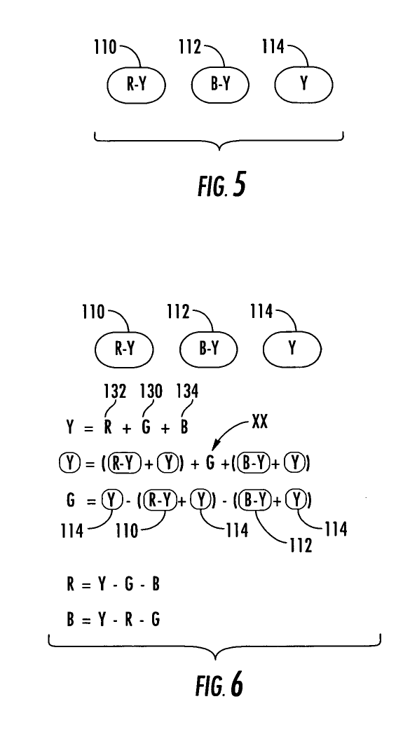

Image processing subsystem 120, FIG. 8, may derive red, green and blue color data from color difference signals 110 and 112 and monochromatic data 114, where the three colors used by the illumination source are the primary colors green 130, red 132, and blue 134. For example the color green 130 is derived by image processing subsystem 120 as shown in FIG. 6 since it is known that the sum of red(R)+green(G)+blue(B)=Y and ((R−Y)+Y)=R, and ((B−Y)+Y)=B. There are three unknowns and three equations, so it will be apparent that red and blue can also be derived through simple algebraic manipulation. A disadvantage of this approach is that monochromatic data Y will need to be stored in a line buffer in order to compute the color difference signals. On the other hand, however, this line buffer is only ⅓ the size required to store a full color line and is significantly smaller than required in known image capture systems.

In another example, image processing subsystem 120 derives the third color, green 130, FIG. 7, from red color data 97, blue color data 99, and monochromatic data 90. Third color green 130 is derived as shown in FIG. 7 since it is known that the sum of red+green+blue=Y, and all values are known except for third color green 130. In this example, the red and blue color data is shown as compressed via an algorithm in accordance with the present invention, as discussed below. In this example, third color 130, green, is derived by processing subsystem 120, FIG. 8.

It will be understood by those of ordinary skill in the art that any color can be chosen as the “third” color to be derived by image processing subsystem 120, and that the subject invention is not limited to any particular color, although it may be advantageous to choose blue as the derived color because of its poorer perception by the human eye and thus the lack of need for high resolution.

In accordance with the subject invention, by using a monochromatic exposure as one of the three required exposures high quality monochromatic data can be captured without being dependent on complete stoppage of the motor due to the strobe effect previously discussed. Thus scanning speed will be increased because the imaging of the next scanning line may be commenced before the motor step is completely finished. In contrast, as noted, conventional color image capture systems using a line scanner require the motor to be completely or nearly completely stopped before imaging in order to avoid color component (i.e. red, green, blue) registration issues such as fringing effects. Further, since in conventional systems monochromatic data must be derived from red, green and blue data by the image processing system, high resolution monochromatic data cannot be achieved without waiting for the motor to be completely or nearly stopped in such a conventional color image capture system.

Further details of the systems and methods of the present invention will now be described.

In one example, color image capture system 12 of the subject invention, FIG. 8, includes illumination source 24 for directing monochromatic light 64 to image 27 to be captured when all three LEDs 68, 70, and 72 are turned on. In one embodiment, illumination source 24 includes red light-emitting diode 68, green light-emitting diode 70, and blue light-emitting diode 72. As noted, in accordance with the present invention any sources of light, and any set of primary colors, or any number of colors that when combined produce monochromatic light, may be used.

Image sensor 26 senses light 76 reflected from, or light 78 transmitted through, image 27 to produce image signal 34 in response, and controller system 32 provides timing and control signals to illumination source 24 and image sensor 26. Controller subsystem 32 is responsive to image signal 34 and is configured to control illumination source 24 to expose image portion 80 to or with monochromatic light 64; to expose image portion 80 to or with one color light from either red light-emitting diode 68, green light-emitting diode 70, or blue light-emitting diode 72; and to expose image portion 80 to or with another color light from either red light-emitting diode 68, green light-emitting diode 70, or blue light-emitting diode 72; the latter color being different than the initial color.

In one embodiment, image portion 80 is first exposed to monochromatic light 64; then image portion 80 is exposed to red light from red light-emitting diode 68; after which image portion 80 is exposed to green light-emitting diode 70. In order to achieve these light exposures, controller subsystem 32 is configured to energize red light-emitting diode 68, green light-emitting diode 70, and blue light-emitting diode 72 simultaneously to monochromatically expose portion 80 of image 27. Controller subsystem 32 is also configured to energize only one of red light-emitting diode 68, green light-emitting diode 70, or blue light-emitting diode 72 to expose image portion 80 with one color, and is further configured to energize only one of red light-emitting diode 68, green light-emitting diode 70, or blue light-emitting diode 72 to expose image portion 80 with another color.

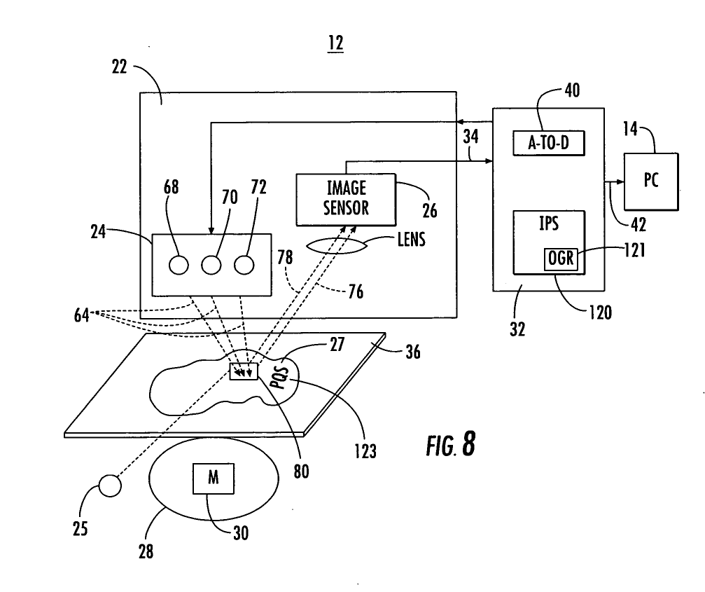

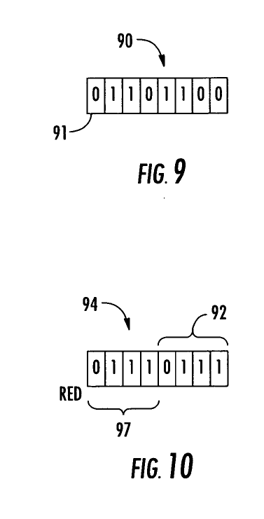

When image 27, including image portion 80, is exposed to monochromatic light 64 that is a combination of all three colors 68, 70 and 72, light 76 reflected from or light 78 transmitted through image portion 80, image sensor 26 for sensing light produces image signal 34 in response. Controller subsystem 32 is further configured to output full resolution monochromatic data in response to the monochromatic exposure of image portion 80. In this way, color image capture system 12 provides sufficient data for image analysis programs such as OCR applications, unlike known color systems which use multiple color sources to produce color information and images and where monochromatic data must be derived from the color data. The subject invention thus produces a monochromatic image data that satisfies the requirements for an image analysis program to produce high quality results. Moreover, since all three color lights are used to produce monochromatic white light, that light is brighter, resulting in a shorter required exposure time and a more effective stroboscopic effect and a faster scan An example of full, uncompressed monochromatic data 90 in 8-bit format is shown in FIG. 9, including the most significant bit 91.

Additionally, when image 27, FIG. 8, including image portion 80, is exposed to or with one color light, controller subsystem 32 is configured to output compressed color data in response to the color exposure. In one example in accordance with the subject invention, controller subsystem 32 ignores or masks off predetermined least significant bits 92, FIG. 10 of color data 94 in order to compress color data 94. The result is compressed color data 97. By ignoring or masking off least significant bits 92, less data is sent but resolution and color fidelity is sacrificed. The trade-off of speed for less resolution or color fidelity is a good one where very high quality color replication is not essential. As shown in the example of FIG. 10, the last four bits are the predetermined least significant bits 92, and color data 94 is red color data. It will be apparent to those of ordinary skill in the art that the predetermined least significant bits 92 to be ignored can be any number of bits depending upon the extent of resolution desired, and that color data 94 is not limited to red color data. It will also be apparent to those of ordinary skill in the art that other compression schemes may be used with the present invention, such as averaging the color data, as well as LZW and RLE compression discussed above, and that the subject invention is not limited to any particular type of compression scheme. Thus, color data of acceptable quality for viewing by the human eye, at increased speed, is produced.

Image processing subsystem 120, FIG. 8, typically includes an image analysis program (e.g.) optical character recognition (OCR) program 121, as known to those skilled in the art, for detecting image characters 123. Alternately, image processing subsystem 120 may be included in computing device 14, and as known in the art, it is usually included in computing device 14. Image processing subsystem 120 is responsive to full resolution monochromatic data 90, FIG. 9, for detecting or resolving image characters 123, for example, and also is responsive to compressed color data 97, FIG. 10. Additionally, image processing subsystem 120 is configured to derive or resolve at least a third color from compressed color data 97 and full resolution monochromatic data 90, and/or to derive red, green and blue color data from color difference signals 110, 112 and monochromatic data 114, FIGS. 6 and 7, as discussed in more detail above.

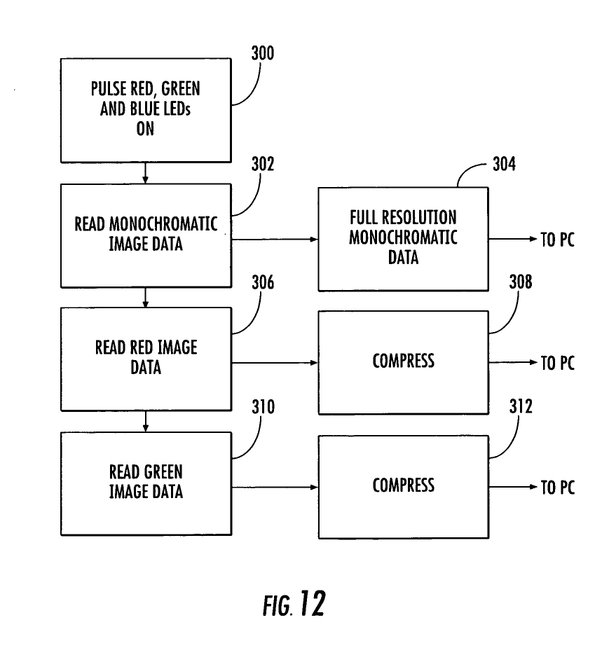

The embodiments previously described utilize a linear scanning system, as described herein, which includes motor 30 and roller 28. However, they would work equally well with a two-dimensional scanner as known in the art. In such a system, instead of scanning line by line and exposing each line to monochromatic light, then one color, then a second color, the scanner system emits a single flash of monochromatic light to expose the entire image to be captured, i.e. image 27 in FIG. 8. The monochromatic data for the entire image is then read. Similarly, the scanner system emits a flash of one color light and data is read for that color, then the scanner system emits a flash of a second color light and data is read for that color (similar to steps 61, 67, 73 in the sequence illustrated in FIG. 4A and FIG. 12). In such a system, however, motor 30 and roller 28 are absent. Illumination source 24 directs a flash of light, from one or more of the LEDS 68, 70, 72. In this case, controller subsystem 32 is configured to expose at least a portion 80 of image 27 to the flash of monochromatic light. Also, illumination source 24, controller subsystem 32 and image sensor 26 may be configured as set forth in the various embodiments and examples herein. Additionally, in a similar manner to the examples and descriptions herein, full resolution monochromatic data and compressed color data is transferred.

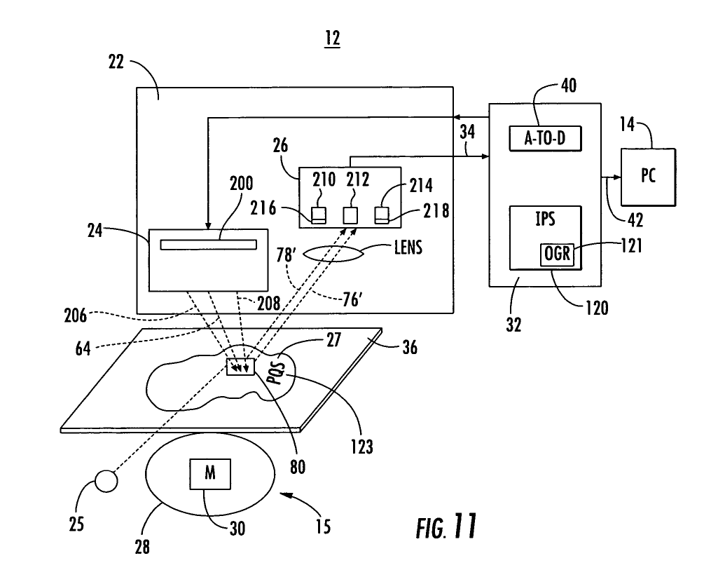

In a further embodiment of the system and method of the color image system of the present invention, illumination source 24, FIG. 11, includes monochromatic light source 200 such as white light. Notably, the monochromatic light source 200 may include three color LEDs 68, 70, 72 as shown in FIG. 8. However, in this embodiment, image sensor 26, FIG. 11, includes a plurality of at least three types of sensing elements 210, 212, 214 for sensing light 76′ reflected from or light 78′ transmitted through image 27, and image sensor 26 produces image signal 34 in response. These sensor elements are arranged as a linear or 2D array. Sensing elements 210 and 214 each include a different color filter 216, 218 for filtering all but a predetermined color, such that each of the sensing elements 210 and 214 is sensitive to only one color. As before, controller subsystem 32 is responsive to image signal 34 and is configured to control illumination source 24 to expose image portion 80 to monochromatic light 64. Controller subsystem 32 is further configured to output full resolution monochromatic data and compressed color data in response to the monochromatic exposure of image 80.

Yet another embodiment is similar in structure and function in all respects to the previous embodiment, except that sensing elements 210 and 214 are without filters 216 and 218. Instead, in this embodiment sensing elements 210 and 214 are each configured to be sensitive to a different predetermined color.

It can be seen that the latter two embodiments may be utilized with a linear scanning system as described herein, which would include motor 30 and roller 28. However, the latter two embodiments would work equally well with a two-dimensional scanner as known in the art. In such a system, instead of scanning line by line and exposing each line to monochromatic light, then one color, then a second color, the scanner system emits a flash of monochromatic light, thus exposing the entire image to be captured to monochromatic light, i.e. image 27 in FIG. 11. In such a system, motor 30 and roller 28 are absent. Illumination source 24 directs a flash of light, for example, from monochromatic light source 200. In this case, controller subsystem 32 is configured to expose at least a portion 80 of image 27 to the flash of light. Also, illumination source 24, controller subsystem 32 and image sensor 26 may be configured as set forth in the various embodiments and examples herein. Additionally, in a similar manner to the examples and descriptions herein, full resolution monochromatic data and compressed color data is transferred.

In one such example, the operation of controller subsystem 32 is set forth in FIG. 12. In step 300, the light source, i.e. red, green and blue LEDs, is turned on, creating monochromatic light from illumination source 24. Monochromatic image data is output by image sensor 26 therefrom. The monochromatic image data is read by controller 32, step 302, and full resolution monochromatic data is transmitted, step 304, to the computing device such as a PC. The red image data is read, step 306, then compressed and transmitted, step 308, to the computing device. The green image data is read, step 310, then compressed and transmitted, step 312, to the computing device. Thus, both full resolution monochromatic data and compressed color data are transferred. However, the full resolution monochromatic data, and the compressed color data of two different colors is sufficient to derive a third color. As noted, the monochromatic data may be uncompressed, compressed with lossless compression, or compressed so that the data is sufficient for OCR, such that full resolution monochromatic data is transferred. Thus, for both linear and two-dimensional scanners, the subject invention provides data sufficient for high accuracy image analysis (i.e. OCR) and lower fidelity color images, the latter of which are more than sufficient for low resolution image analysis or cases where data will only be viewed by a human.

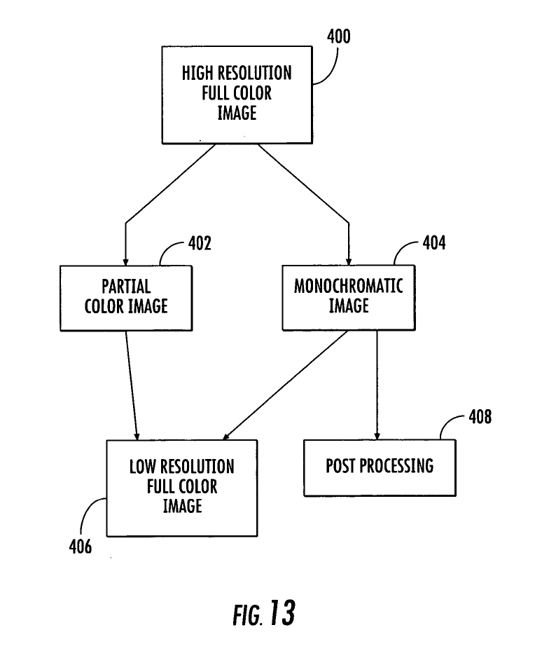

Thus far the subject invention has been primarily disclosed with reference to a scanner device when used in connection with scanning and also other imaging systems, however, FIG. 13 describes the inventive algorithm in a broader sense.

High resolution full color image or data 400 may be produced by a scanning device, any one or two dimensional image sensor with any arrangement of filters or sensing elements preconfigured to be sensitive to a particular color of light, or other imaging systems such as a digital camera that are capable of producing color image data. Derived from high resolution full color image data 400 are partial color image data 402 and monochromatic image data 404. Alternatively, partial color image data 402 may be produced as set forth in steps 67-75, FIG. 4A. Monochromatic image data 404 may be produced as set forth in steps 61-65, FIG. 4A. But, partial color image data 402 and monochromatic image data 404 may also be derived mathematically directly from high resolution full color image 400.

From partial color image data 402 and monochromatic image data 404, low resolution full color image data 406 is derived as set forth in FIGS. 6-7. Monochromatic image data 404 may be used in post processing techniques 408, FIG. 13 as set forth above (e.g., optical character recognition).

Thus, the subject invention has wide applicability, for example in scanners but also in imaging systems used to image component parts and the like. Specifically, the inventive algorithms presented here apply to any situation in which a source for full resolution color data is available and that data needs to be transferred to a receiver where such receiver requires high resolution monochromatic data but can accept lower quality color data.

The present invention utilizes monochromatic image data, and image data from, two colors compressed and encoded to derive a third color as described herein, resulting in a faster and less costly color image capture system and document scanning system that do not require a large memory or line buffer on-board the image capture device or expensive fast processors. Utilizing the system and method of this invention, it is possible to reduce the total data transmitted for a color image. Also in contrast to currently known systems and approaches, the subject invention substantially increases the speed of color image transfer while retaining the full fidelity of monochromatic data.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A color image capture system comprising:
an illumination source for directing monochromatic light and light of N different colors, where N is a number greater than or equal to two, to an image to be captured;
an image sensor for sensing light reflected from or transmitted through the image and to produce an image signal in response; and
a controller subsystem, responsive to the image signal and configured to control the illumination source to:
expose at least a portion of the image monochromatically,
expose said portion of the image N times with said N colors, one at a time to thereby speed up the exposure of the image and/or reduce the memory and processor requirements of the capture system.

2. The color image capture system of claim 1 in which the controller subsystem is further configured to output full resolution monochromatic data in response to the monochromatic exposure and to output compressed color data in response to the color exposures.

3. The color image capture system of claim 2 further including an image processing subsystem responsive to the fill resolution monochromatic data and the compressed color data.

4. The color image capture system of claim 3 in which said image processing subsystem is configured to derive missing color information from the compressed color data and the monochromatic data.

5. The color image capture system of claim 3 in which said image processing subsystem is configured to derive at least a third color from the compressed color data and the monochromatic data.

6. The color image capture system of claim 3 in which said image processing subsystem further includes an optical character recognition program for detecting image characters based on the monochromatic data.

7. The color image capture system of claim 2 in which the controller subsystem is configured to output color difference signals based on the monochromatic data.

8. The color image capture system of claim 7 further including an image processing subsystem configured to derive color information from the color difference signals and the monochromatic data.

9. The color image capture system of claim 2 in which the controller subsystem is configured to ignore predetermined least significant bits of the color data in order to compress the color data.

10. The color image capture system of claim 1 in which the illumination source includes multiple light-emitting diodes configured to produce monochromatic light.

11. The color image capture system of claim 1 in which the illumination source includes red, green, and blue light-emitting diodes.

12. The color image capture system of claim 11 in which the controller subsystem is configured to energize the red, green, and blue light emitting diodes simultaneously to monochromatically expose said portion of the image.

13. The color image capture system of claim 12 in which said controller subsystem is configured to energize only one of the red, green, and blue light emitting diodes to expose said image portion with one color and to energize only one other color light emitting diode to expose said image portion with another color.

14. The color image capture system of claim 1 in which the image sensor includes photodiodes.

15. The color image capture system of claim 14 in which the photodiodes are arranged in a linear array.

16. The color image capture system of claim 14 in which the photodiodes are arranged in a two-dimensional array.

17. The color image capture system of claim 1 further including a motion mechanism for providing relative motion between a document containing the image and the image sensor.

18. The color image capture system of claim 1 in which the controller subsystem includes a memory buffer and is configured to compensate for dark current.

19. The color image capture system of claim 18 in which the memory buffer is less than 100 bytes.

20. The color image capture system of claim 18 in which the memory buffer is 64 bytes.

21. A document scanning system comprising:
an imaging subsystem including:
an illumination source including N differently colored light sources, where N is a number greater than or equal to three;
an image sensor for sensing light reflected from or transmitted through a document and for producing an image signal in response;
a motion mechanism for providing relative motion between the imaging subsystem and the document; and
a controller subsystem responsive to the image signal and for controlling the illumination source and the motion mechanism, the controller subsystem configured to:
pulse predetermined light sources simultaneously to expose at least a portion of the document monochromatically,
pulse one of the light sources to expose said portion of said document in one color, and pulse the remaining light sources N-2 times with a different light source each time.

22. The document scanning system of claim 21 in which the controller subsystem is further configured to output full resolution monochromatic data in response to the monochromatic exposure and to output compressed color data in response to the color exposures.

23. The document scanning system of claim 22 further including an image processing subsystem responsive to the full resolution monochromatic data and the compressed color data.

24. The document scanning system of claim 23 in which said image processing subsystem is configured to derive at least a third color from the compressed color data and the monochromatic data.

25. The document scanning system of claim 23 in which said image processing subsystem is configured to derive missing color information from the compressed color data and the monochromatic data.

26. The document scanning system of claim 24 in which said image processing subsystem further includes an optical character recognition program for detecting image characters based on the monochromatic data.

27. The document scanning system of claim 22 in which the controller subsystem is configured to output color difference signals based on the monochromatic data.

28. The document scanning system of claim 27 further including an image processing subsystem configured to derive color information from the color difference signals and the monochromatic data.

29. The document scanning system of claim 22 in which the controller subsystem is configured to ignore predetermined least significant bits of the color data in order to compress the color data.

30. The document scanning system of claim 21 in which the light sources are light emitting diodes.

31. The document scanning system of claim 21 in which the light sources are red, green, and blue light-emitting diodes.

32. The document scanning system of claim 21 in which the image sensor includes photodiodes.

33. The document scanning system of claim 32 in which the photodiodes are arranged in a linear array.

34. The document scanning system of claim 32 in which the photodiodes are arranged in a two dimensional array.

35. A method of capturing an image, the method comprising:
exposing at least a portion of an image monochromatically to produce a monochromatic image signal;
exposing said portion of the image with light of N different colors, where N is a number greater than or equal to 2, to produce N color image signals;
compressing the color image signals; and
resolving missing color information from the compressed N color image signals and the monochromatic image signal.

36. A method of capturing an image, the method comprising:
exposing at least a portion of an image monochromatically to produce a monochromatic image signal;
exposing said portion of the image with light of a first color to produce a color image signal;
exposing said portion of the image with light of a second color to produce a second color image signal;
compressing the first and second color image signals; and
resolving a third color image signal from the compressed first and second color image signals and the monochromatic image signal.

37. The method of capturing an image of claim 36 further including detecting characters present in the image from the monochromatic image signal.

38. The method of capturing an image of claim 37 in which detecting characters present in the image from the monochromatic image signal is performed by an optical character recognition program.

39. The method of capturing an image of claim 36 in which compressing the first and second image signals includes ignoring predetermined least significant bits of color image data.

40. The method of capturing an image of claim 36 further including moving said document containing the image after exposing said portion of the image with light of a second color.

41. The method of capturing an image of claim 36 in which exposing at least a portion of the image monochromatically includes energizing red, green and blue light emitting diodes simultaneously.

42. The method of capturing an image of claim 36 in which exposing at least a portion of the image with light of said first color includes energizing a first light emitting diode to expose said image portion with said first color.

43. The method of capturing an image of claim 42 in which the first color is red.

44. The method of capturing an image of claim 36 in which exposing at least a portion of the image with light of said second color includes energizing a second light emitting diode to expose said image portion with said second color.

45. The method of capturing an image of claim 44 in which the second color is green.

46. The method of capturing an image of claim 36 in which the monochromatic image signal includes full resolution monochromatic data.

47. The method of capturing an image of claim 36 in which the first and second compressed color image signals include compressed color image data for said first signal and compressed color image data for said second signal.

48. A method of document scanning, the method comprising:
pulsing a plurality of color light sources simultaneously to expose at least a portion of a document monochromatically;
pulsing a first color light source to expose said portion of said document to a first color;
pulsing a second color light source to expose said portion of said document to a second color;
sensing light reflected from or transmitted through the document; and producing an image signal in response.

49. A method of document scanning, the method comprising:
pulsing a first color light source, a second color light source, and a third color light source simultaneously to expose at least a portion of a document monochromatically;
pulsing the first color light source to expose said portion of said document to the first color;
pulsing the second color light source to expose said portion of said document to the second color;
sensing light reflected from or transmitted through the document; and
producing an image signal in response.

50. The method of document scanning of claim 49 further including providing relative motion between said light sources and said document after exposing said document portion to said second color.

51. The method of document scanning of claim 49 further including outputting full resolution monochromatic data in response to exposing said document portion to said first, second, and third light simultaneously.

52. The method of document scanning of claim 51 further including outputting first color data in response to exposing said document portion to the first color.

53. The method of document scanning of claim 52 further including outputting second color data in response to exposing said document portion to the second color.

54. The method of document scanning of claim 53 further including compressing said first color data.

55. The method of document scanning of claim 54 further including compressing said second color data.

56. The method of document scanning of claim 55 in which compressing said first and second color data includes ignoring least significant bits of said first and second color image data.

57. The method of document scanning of claim 55 further including deriving a third color from said compressed first and second color data and said monochromatic data.

58. The method of document scanning of claim 51 further including detecting image characters based on the full resolution monochromatic data.

59. The method of document scanning of claim 51 further including outputting color difference signals based on the full resolution monochromatic data.

60. The method of document scanning of claim 59 including deriving color data from the color difference signals.

61. A method of capturing an image, the method comprising:
directing monochromatic light onto an image to be captured;
sensing monochromatic light reflected from the image and producing monochromatic image data;
directing light of at least a first color onto the image to be captured;
sensing the first color light reflected from the image and producing first color image data;
directing light of at least a second color onto the image to be captured;
sensing the second color light reflected from the image and producing second color image data;
compressing the first and second color image data; and
producing an image signal in response.

62. A color image capture system comprising:
an illumination source for directing monochromatic light to an image to be captured;
an image sensor including at least three sensing elements for sensing light reflected from or transmitted through the image and to produce an image signal in response, two of the sensing elements configured to be sensitive to a different predetermined color; and
a controller subsystem, responsive to the image signal and configured to control the illumination source to expose at least a portion of the image monochromatically and further configured to output full resolution monochromatic data and to output compressed color data.

63. A color image capture system comprising:
an illumination source for directing monochromatic light and light of first and second colors to an image to be captured;
an image sensor for sensing light reflected from or transmitted through the image and to produce an image signal in response; and
a controller subsystem, responsive to the image signal and configured to control the illumination source to:
expose at least a portion of the image monochromatically, output full resolution monochromatic data in response to the monochromatic exposure, and transmit the full resolution monochromatic data to a computing device,
expose said portion of the image with said first color, output compressed first color data in response to the first color exposure, and transmit compressed first color data to the computing device, and
expose said portion of the image with said second color, output compressed second color data in response to the second color exposure, and transmit compressed second color data to the computing device.

64. The color image capture system of claim 63 further including an image processing subsystem responsive to the full resolution monochromatic data and the compressed color data.

65. The color image capture system of claim 64 in which said image processing subsystem is configured to derive a third color from the compressed color data and the monochromatic data.

66. A color image capture system comprising:
an illumination source for directing light to an image to be captured;
an image sensor for sensing light reflected from or transmitted through the image and to produce an image signal in response; and
a controller subsystem, responsive to the image signal and configured to:
output full resolution monochromatic data and transmit the full resolution monochromatic data to a computing device,
output compressed color data of a first color and transmit the compressed first color data to the computing device, and
output compressed color data of a second color and transmit the compressed second color data to the computing device.

67. The color image capture system of claim 66 further including an image processing subsystem responsive to the full resolution monochromatic data and the compressed color data.

68. The color image capture system of claim 67 in which said image processing subsystem is configured to derive a third color from the compressed color data and the monochromatic data.

69. A method of capturing an image, the method comprising:
exposing at least a portion of an image monochromatically to produce a monochromatic image signal, outputting full resolution monochromatic data in response to the monochromatic exposure, and transmitting the full resolution monochromatic data to a computing device;
exposing said portion of the image with light of a first color to produce a first color image signal, outputting compressed first color data in response to the first color exposure, and transmitting the compressed first color data to the computing device; and
exposing said portion of the image with light of a second color to produce a second color image signal, outputting compressed second color data in response to the second color exposure, and transmitting the compressed second color data to the computing device.

70. The method of capturing an image of claim 69 further including the step of resolving a third color image signal from the compressed first and second color image signals and the monochromatic image signal.

71. A method of capturing an image, the method comprising:
exposing at least a portion of an image to monochromatic light;
sensing light reflected from or transmitted through the image and producing an image signal from said sensed light;
outputting full resolution monochromatic data and transmitting said full resolution monochromatic data to a computing device;
outputting compressed first color data and transmitting said compressed first color data to the computing device; and
outputting compressed second color data and transmitting said compressed second color data to the computing device.

72. The method of capturing an image of claim 71 further including the step of resolving a third color image signal from the compressed first and second color image signals and the monochromatic image signal.

73. A method of capturing an image, the method comprising:
exposing at least a portion of an image monochromatically to produce a monochromatic image signal, outputting full resolution monochromatic data in response to the monochromatic exposure, and transmitting the full resolution monochromatic data to a computing device;
exposing said portion of the image with light of a first color to produce a first color image signal, outputting compressed first color data in response to the first color exposure, and transmitting the compressed first color data to the computing device;
exposing said portion of the image with light of a second color to produce a second color image signal, outputting compressed second color data in response to the second color exposure, and transmitting the compressed second color data to the computing device; and
compensating for dark current each time before exposing the portion of the image monochromatically, with light of the first color, and with light of the second color.

74. A method comprising:
producing partial color image data;
producing monochromatic image data; and
from the partial color image data and the monochromatic image data, deriving low resolution full color image data.

75. The method of claim 74 in which both the partial color image data and the monochromatic image data are derived from high resolution full color image data.
